(19) United States
(12) Patent Application Publication
(10) Pub. No.: US 2011/0001332 A1
(43) Pub. Date: Jan. 6, 2011

(54) SHADE PANEL ASSEMBLY FOR ALL VEHICLES

(76) Inventor: James Weber, West Bloomfield, MI (US)

Correspondence Address: JAMES MARC LEAS;Law Office Of James Marc Leas, 37 BUTLER DRIVE, S. BURLINGTON, VT, 05403, US

(21) Appl. No.: 12/831,025

(22) Filed: Jul. 6, 2010

Related U.S. Application Data
(60) Provisional application No. 61/223,056, filed on Jul. 5, 2009.

(51) Int. Cl. B60J 3/02

(52) U.S. Cl. 296/97.6; 296/97.9

(57) ABSTRACT

In some embodiments, a new add-on or factory installed shade panel assembly for a vehicle which creates improved lateral and vertical adjustments for sun blocking positions. Optional attaching methods are wrap around straps with Velcro™ ends, suction cups (for window attachment), or a concealed magnetic strip inside the visor which permits infinite lateral and vertical adjustment of 1 or 2 magnetic shade panels. In some embodiments, the shade panel assembly offers the advantage of precise tunable sun blocking for a low sun situation while still maintaining good vision of a traffic light and other vehicles. The proposed embodiments provide a new a low cost fabric type visor, which is durable, color coordinated, and fits all cars and sizes-left or right hand drive.

### FIELD OF THE INVENTION

This invention relates to sun visors in vehicles.

### BACKGROUND OF THE INVENTION

Prior art visors often have additional appendages permanently affixed to the vehicle or the vehicle's existing sun visor. Typically these appendages extend from the existing visor laterally and to the right or center of the vehicle. Some versions have a panel with its own rod and pivot in the vehicle's roof allowing it to rotate 90 degrees to the top of the side window while the main visor remained at the windshield. Portable versions of these are typically attached to the existing visor with elastic straps. Various features are frequently added to the add-on prior art including multiple pockets to hold CDs, pockets for vehicle registration papers, and zippered pockets for valuables, pencil holders, and sun glasses case or holder.

Prior art visors, either portable add-on or factory-installed on the vehicle, have had limited adjustment. They often only worked on the front left hand side windshield and only extended laterally inward. Portable visors typically do nothing more than add lateral length to an existing vehicle's visor or they add other features not related to improved driver vision (i.e. CD pockets, pencil holders, etc.) Prior art does not show any solutions for customized vertical adjustment. Previous visors typically have a front, back, top and bottom making them not practical for the passenger side visor or side and rear window usage since they have no other attachment method other than elastic straps wrapping around an existing vehicle's visor.

One particularly annoying problem not addressed by current art is described here. During certain periods of the day the sun is low on the horizon so that the driver, if driving in a particular direction, is looking almost directly into the sun in order to drive the vehicle. Prior art visors do not typically adjust low enough to block a low sun since they would also block the driver's view of the road, of traffic signs and of traffic lights, which is clearly an unsafe driving condition.

A problem with prior art visors is that when using elastic straps for attachment, with heat and aging, the elastic loses its stretchability and will not hold snug to an existing visor. Also prior art visors tend to be handed and open at the right end. They are not easily used on a right hand drive vehicle or a passenger side windshield. For rear windows, they have no means of attachment.

### SUMMARY OF THE INVENTION

Some embodiments of this proposed invention has a secondary moveable shade which rotates and adjusts downward as well as laterally. This allows the driver to selectively block out only the low sun on the horizon with a minimal, adjustable width so that only the sun is blocked. The traffic light may be seen on either side of the vertically adjustable member, while visibility on either side of the sun is fully maintained. Furthermore, the extending shade panel may extend to the left or to the right, thus making the same visor convertible for passenger or driver side. Optional suction cups allow the same visor to attach to any side window also. A magnetic embodiment version has a magnetically attached lower member which can adjust vertically and laterally at an infinite variety of positions. The grommet embodiment has a pivot created by a grommet attaching the corners of the lateral and vertical shade members. The vertical member then rotates downward and slides with the lateral panel to selectively block out only the low sun. Thus, this patent offers greater vision enhancement to make for potentially safer driving. Its interchangeability enables additional sun protection for passengers and it fits in all cars, all positions, without degradation due to heat and sun.

Some embodiments of this invention provide a shade panel assembly with the advantage of extra vertical and lateral sun-blocking adjustment for drivers, passengers and rear seat occupants. The vertical adjustment can be fine-tuned by the operator to block out only the sun while still allowing visibility on either side of the sun. Additionally, in some embodiments, the shade panel assembly has no top, bottom, left or right. It may be totally interchangeable to any position in any the vehicle, extending to the left or the right. Its adjustable Velcro™ straps permit full adjustment to fit any vehicle and they will not loose their tightness with heat or aging. Optional suction cups enable attachment to any rear or side window without an existing visor. In some embodiments, such as, for example, a magnetic embodiment, infinite adjustment positions are provided laterally or vertically. A preferred fabric material for the visor's cover provides a low cost, durable, flexible, color coordinated holder for the shade panels.

### BRIEF DESCRIPTION OF THE DRAWINGS

FIG. 1 is an exploded perspective view of a shade panel assembly in accordance with an embodiment of the present invention;

FIG. 2 is a front elevation view of the components of a cover that is part of the shade panel assembly shown in FIG. 1;

FIG. 2a is a side elevation view of the components shown in FIG. 2;

FIG. 3 is a front elevation view of one of the components shown in FIG. 2 with showing the mounting of attaching straps for mounting the assembly to a sun visor;

FIG. 3a is a side elevation view of the components shown in FIG. 3;

FIG. 4 is a front elevation view of a completed support structure including the cover shown in FIG. 3 and the straps shown in FIG. 2;

FIG. 4a is a side elevation view of the completed support structure shown in FIG. 4;

FIG. 5 is a front elevation view of illustrating the joining of two shade panels that are part of the assembly shown in FIG. 1;

FIG. 5a is a magnified sectional side view of a portion of the two shade panels shown in FIG. 5;

FIG. 6 is a front elevation view of the assembly shown in FIG. 1 with the shade panels deployed to the right and down;

FIG. 7 is a front elevation view of the completed shade panel assembly with the shade panels deployed to the left and down;

FIG. 8 is a perspective view of the completed shade panel assembly

FIG. 9 is another perspective view of the completed shade panel assembly;

FIG. 9a is a side view of the shade panel assembly attached to an existing vehicle sun visor;

FIG. 10 is a perspective view of a shade panel assembly in accordance with another embodiment of the present invention which may be attached to a glass window;

FIG. 11 is a front elevation view of the shade panel assembly shown in FIG. 10 with the shade panels deployed to the left and down;

FIG. 12 is a perspective view of the assemblies shown in FIGS. 8 and 10 installed together in the interior of a vehicle;

FIG. 13 is a perspective view of a shade panel assembly in accordance with another embodiment of the present invention; and

FIG. 14 is a front elevation view of a variant of the assembly shown in FIG. 5.

### DETAILED DESCRIPTION OF THE INVENTION

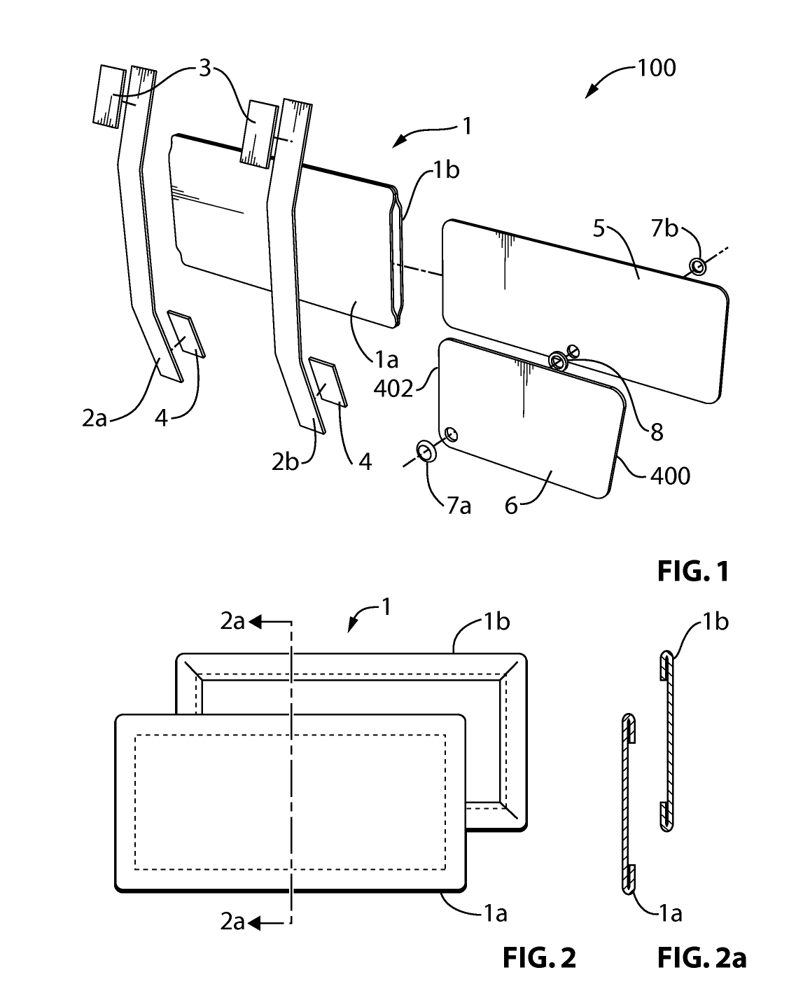

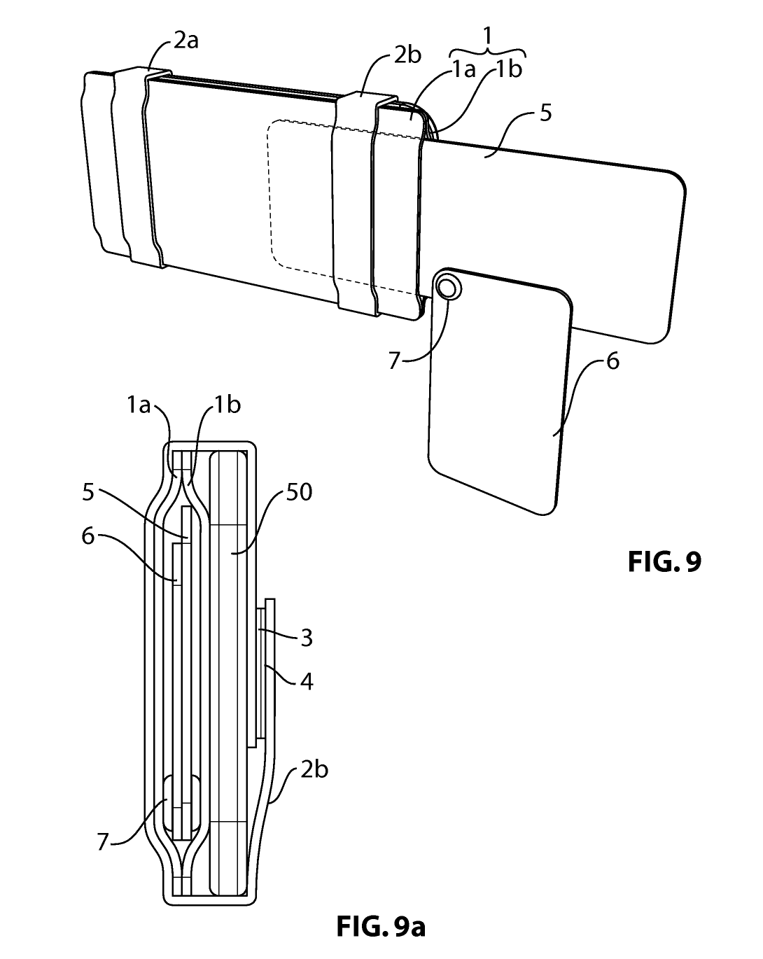

Referring to FIG. 1, an exploded assembly view of a shade panel assembly 100 in accordance with an embodiment of the present invention is presented. The assembly 100 has a cover 1 that is comprised of two hemmed pieces of fabric 1a and 1b. The two pieces of fabric may be any suitable material, such as polyester. The front of the cover 1a has two heavy duty straps 2a and 2b sewn to its left and right edges. Each strap 2a and 2b has two ends. At a first end is a hook panel 3 and at a second end is a loop panel 4. The straps 2a and 2b are sufficiently long so that the hook and loop panels 3 and 4 can connect to each other when the shade panel assembly 100 is mounted to a pre-existing vehicle sun visor shown at 50 (see FIG. 9a). The hook and loop panels 3 and 4 permit the ends of the straps 2a and 2b to releasably connect together, to be adjustable so that the straps can close and lock tightly around different members having different shapes and sizes, such as sun visors in different makes and model of vehicle. The front cover 1a and rear cover 1b are sewn together to form a finished envelope open at both ends to receive the sliding shade panels 5 and 6. The cover 1 along with the straps 2a and 2b with the hook and loop panels 3 and 4 form a support structure for the shade panels 5 and 6.

The shade panels 5 and 6 are crimped together by a grommet 7 formed from grommet halves 7a and 7b which pilot themselves in the pivot holes in the shade panels 5 and 6. Trapped between the panels 5 and 6 is a foam rubber washer 8 which becomes about 50% compressed during crimping thereby providing a constant rotational friction between panels 5 and 6. This friction causes the vertical adjusting (rotating) panel 6 to remain in the position it was set by the operator without slipping. The panel 6 may be referred to as a vertically adjustable shade panel. The foam washer 8 provides a relatively constant and durable friction force minimally influenced by tolerances of fits, crimping overload or shrinkage due to heat and aging. After crimping 5, 6, 7a, 7b, and 8 together, this sliding insert can now be inserted into either end of the cover 1 to make a finished assembly. The shade panels 5 and 6 may be made from any suitable material, such as heavy duty card stock.

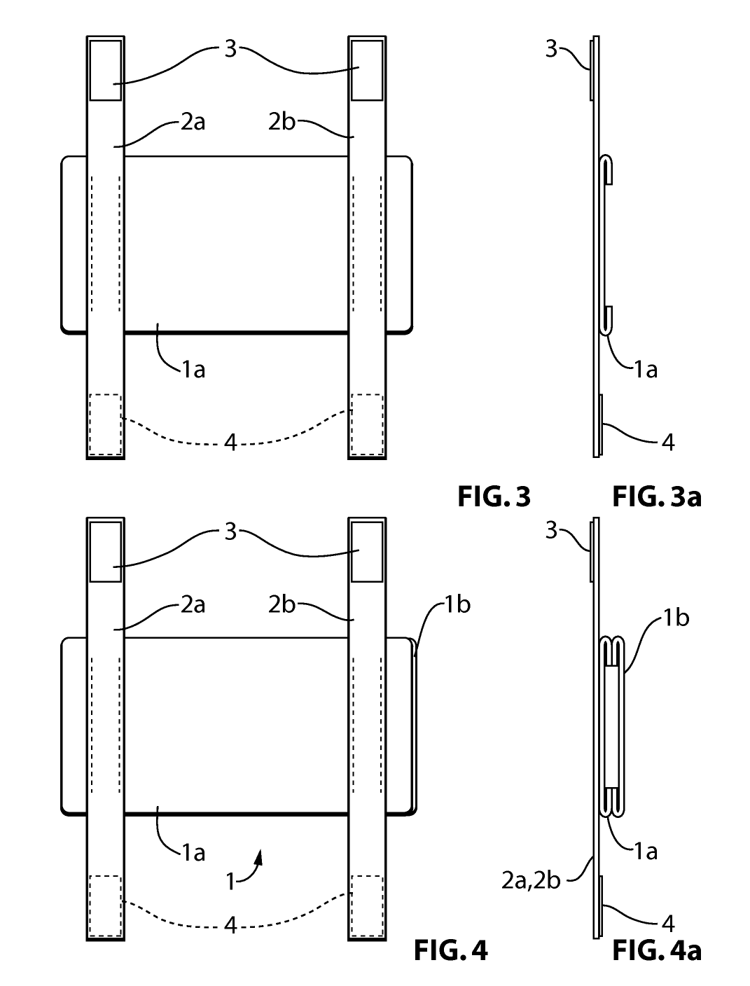

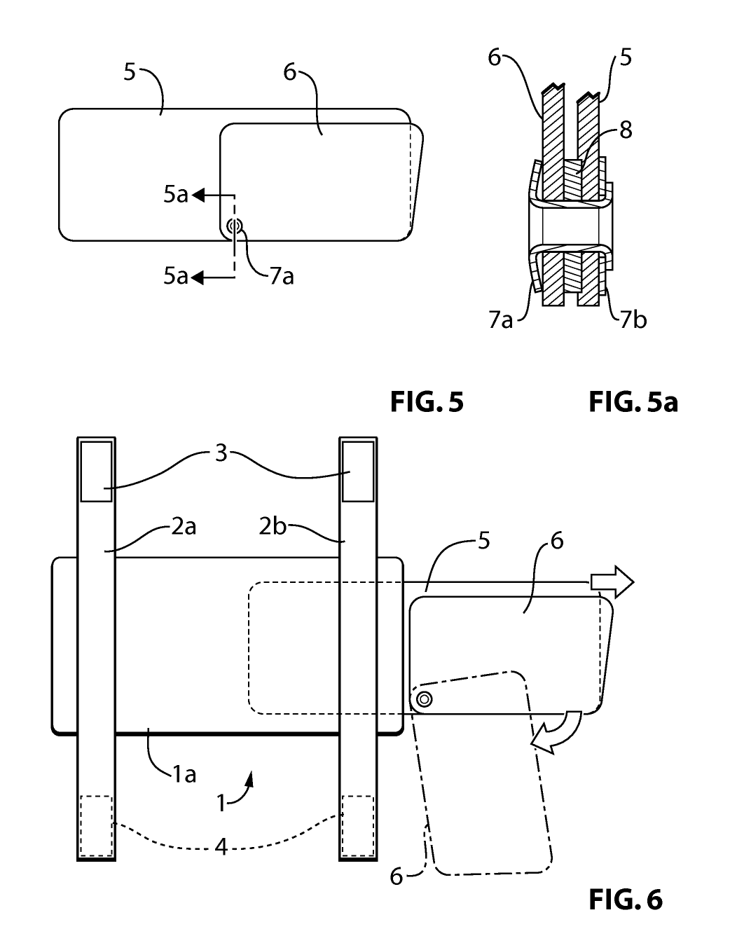

FIGS. 2, 3, 4 and 5 illustrate how the main embodiment is constructed in more detail. FIG. 2 shows the hem sewn on the front cover 1a and the rear cover 1b. Each hem is faced inward for final sewing in order to conceal the hem. FIG. 3 shows how the straps 2a and 2b are sewn to the front cover 1a only so that the ends of the finished cover are not sewn shut. FIG. 4 also shows how hook strip 3 is sewn to one side of straps 2a and 2b and the loop strip 4 is sewn to the opposite end and side of the straps 2a and 2b. Final sewing of cover 1 is done by sewing laterally across the tops and bottoms of 1a, 1b, 2a, and 2b This final sew leaves both ends of the cover open for the sliding panels 5 and 6 to be inserted. FIG. 5 illustrates how the shade panels 5 and 6 are joined together. The close-up cross-section shows the two grommet halves 7a and 7b crimping over each other while trapping and compressing the rubber washer 8 between the panels 5 and 6. After crimping, the sliding panels 5 and 6 are inserted in to one end of the cover 1 thus completing the assembly 100.

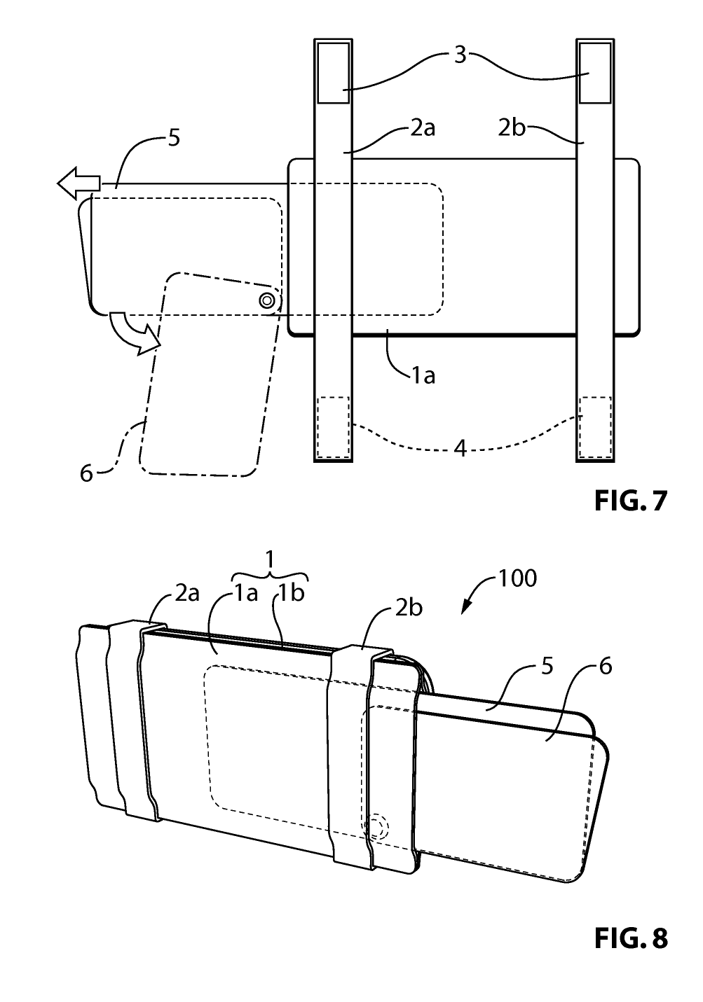

Adjustment function is illustrated in FIGS. 6 and 7. In FIG. 6, the panel 5 is extended 50% of its length to the right. The panel 5 may be referred to as a laterally adjustable shade panel. After panel 6 is exposed during the sliding of panel 5 out of the cover 1, the panel 6 can rotate downward. For right hand steer vehicles, such as in England, the panels 5 and 6 may be installed to extend out from the left side of the cover 1. FIG. 7 shows this opposite handed version with its panel 5 extended out to the left and with a down rotation of panel 6. The panel 6 is shown in FIGS. 6 and 7 in both a first position illustrated by the dashed outline P1 and a second position illustrated by the dashed outline P2. In the first position, the panel 6 may not be substantially lower than the vehicle sun visor 50 (as shown in FIG. 9a). In the second position the panel 6 is lower than in the first position. In the second position the panel 6 is lower than the vehicle sun visor 50.

FIG. 8 shows the assembly 100 with the panel 5 extended laterally outwardly from the sun visor 50 (shown in simple dashed outline). FIGS. 9 and 9a illustrate the fastening of the hook and loop straps 7a and 7b around an existing visor.

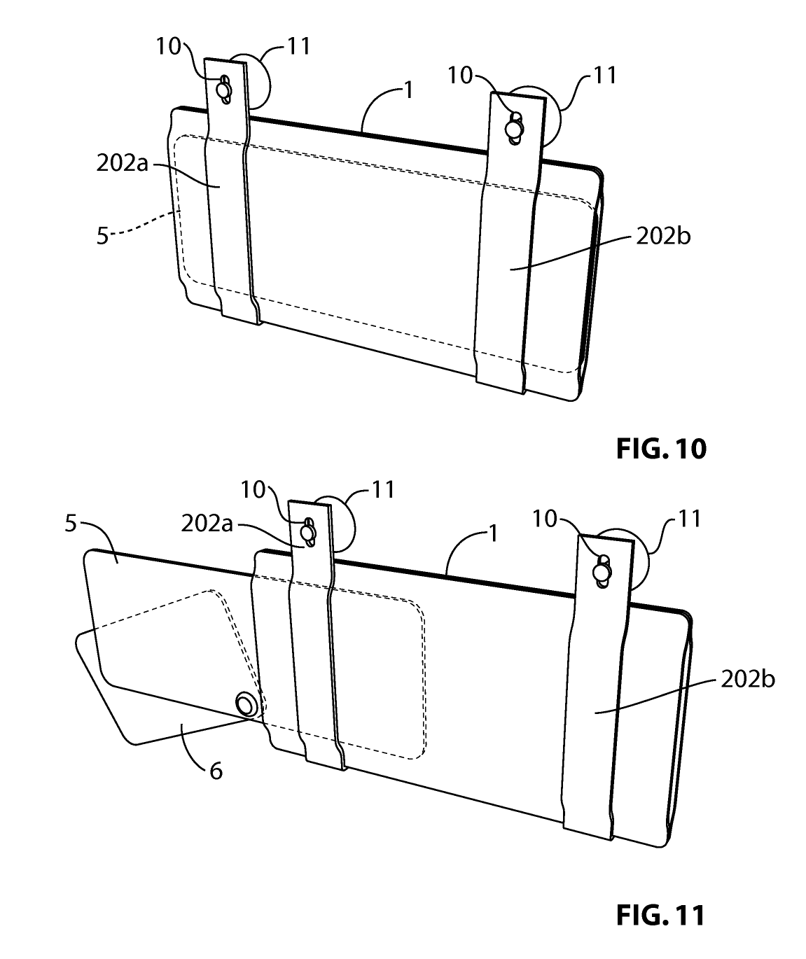

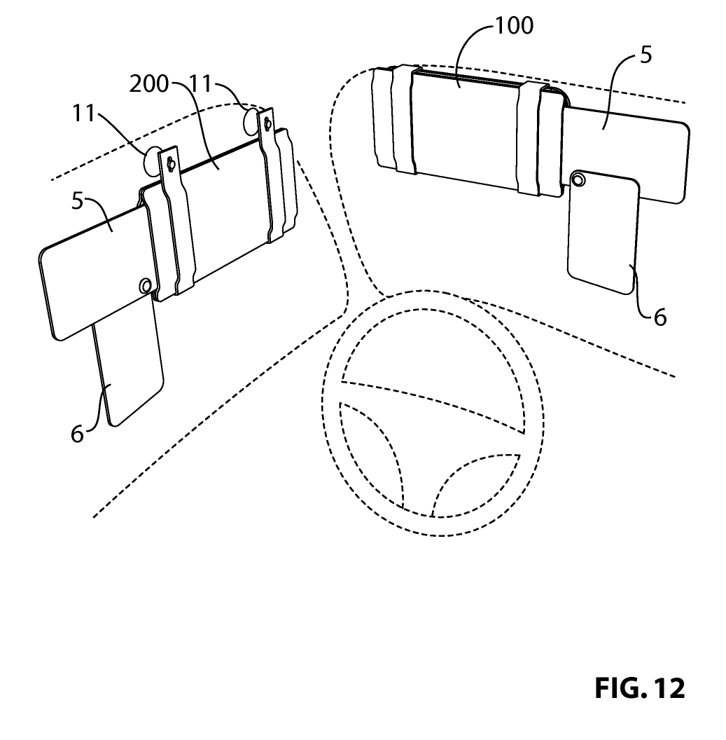

FIGS. 10 and 11 show a shade panel assembly 200 in accordance with another embodiment of the present invention, which uses suction cups 11 attached in button holes 10 of fore-shortened straps 202a and 202b. The same insert panels 5 and 6 and the same cover 1 may be used. This option allows the shade panel assembly 200 to be attached to any window directly. It is valuable for the driver and passenger seat positions and for rear seated children in child-seats who cannot escape a low angled sun from the side.

Both the assembly 100 and the assembly 200 are illustrated as they might appear together in a vehicle interior in FIG. 12. One can see the unique capability for selectively blocking a low sun in FIG. 12 while still being able to view a traffic light.

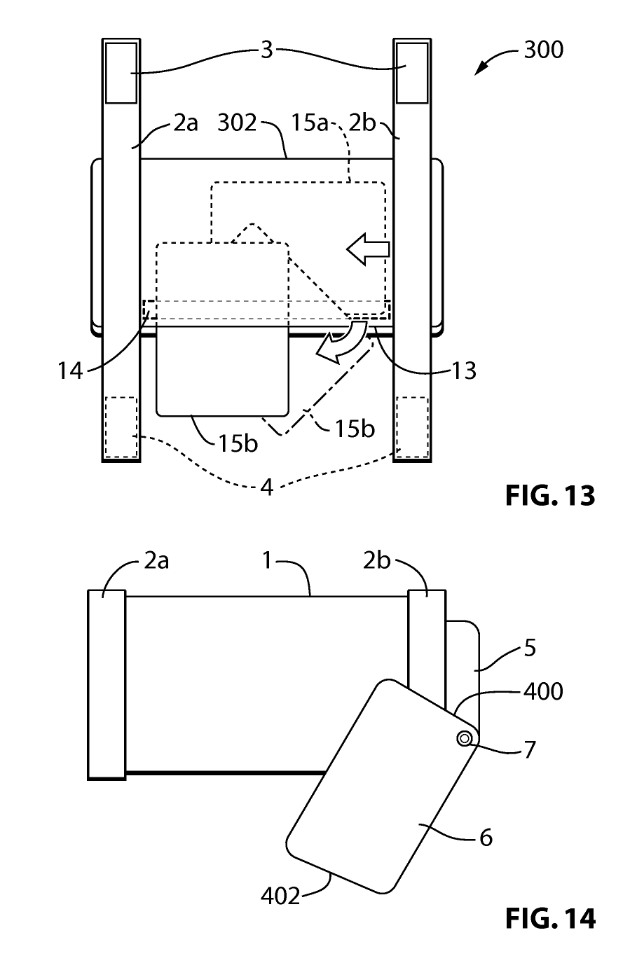

FIG. 13 shows a shade panel assembly 300 in accordance with another embodiment of the present invention. The assembly 300 illustrates the use of two vertically adjustable shade panels 15a and 15b. It will be understood however that a single vertically adjustable shade panel could be used. The cover is shown at 302 and may be similar to the cover 1 (FIGS. 1-9), however, the cover 302 has only one opening 13 at its bottom instead of an opening on each side edge. A magnetic or steel-containing strip 14 is sewn or glued just inside the cover's opening 13 and extends the length of the cover. The panels 15a and 15b are made from flexible magnetic plastic (as used in refrigerator magnets). Panels 15a and 15b will naturally stick to strip 14 thereby holding almost infinite lateral and vertical adjustments of one or two panels 15a and 15b. In this embodiment, the strip 14 itself constitutes a lateral adjustment member. Optionally, the cover 302 may also have an opening along one or both side edges so that another laterally sliding panel 5 could be added.

Reference is made to FIG. 14 which shows an alternative construction wherein the pivot connection between the panel 5 and the panel 6 proximate the lateral edge of the panel 5 instead of being at a roughly central location as it is in the embodiment shown in FIG. 5. Furthermore, the pivot connection is at the distal lateral edge shown at 400 of the panel 6 instead of being at the proximal lateral edge shown at 402, as is the case in the embodiment shown in FIG. 5. This embodiment has several advantage associated with it. One advantage is that, for a given lateral adjustment position for the panel 6, the panel 5 does not extend out any farther from the cover 1 than the panel 6 does. Thus, when the occupant desires a particular lateral position for the panel 6, there is little risk that the rearview mirror of the vehicle will prevent the panel 5 from moving to where it is needed to provide the desired lateral position for panel 6. Another advantage is that the panel 6 may be positioned to block a visual distraction while the panel 5 is extended only very little from the cover 1. The panel 5 and 6 are shown in FIG. 14 with the cover 1 and the support straps 2a and 2b. However, other support structures could be used instead, such as the support structure shown in FIG. 10.

In the embodiments above, the vertically adjustable shade panel 6 has a width that is selected to block the sun or other unwanted visual distractions from the driver or passengers of a vehicle. The vertically adjustable shade panel 6 may have a width that is selected to be smaller than that of the overall sun visor 50. The width of the panel 6 may be selected based on the apparent size of the sun to occupants of the vehicle. The panel 6 is useful for blocking the sun, for blocking headlights from oncoming traffic or other similar visual distractions. For example, the panel 6 may be just a few inches wide, so that it permits the driver to block the visual distraction while still being able to see traffic lights, traffic signs and the like.

While the above description constitutes a plurality of embodiments of the present invention, it will be appreciated that the present invention is susceptible to further modification and change without departing from the fair meaning of the accompanying claims.

1. A shade panel assembly, comprising:
a support structure that connects to a vehicle sun visor;
a lateral adjustment member that is laterally slidably connected to the support structure; and
a vertically adjustable shade panel that is connected to the lateral adjustment member and wherein the vertically adjustable shade panel is vertically movable relative to the lateral adjustment member between a first position wherein the vertically adjustable shade panel extends substantially lower than the vehicle sun visor, and a second position wherein the vertically adjustable shade panel does not extend substantially lower than the vehicle sun visor.

2. A shade panel assembly as claimed in claim 1, wherein the vertically adjustable shade panel is riveted via a grommet pivot to the lateral adjustment member.

3. A shade panel assembly as claimed in claim 1, wherein the lateral adjustment member is a laterally adjustable shade panel.

4. A shade panel assembly as claimed in claim 1, wherein the vertically adjustable shade panel has a width that is less than a selected value.

5. A shade panel assembly as claimed in claim 4, wherein the selected value is selected based on the apparent width of the sun from inside the vehicle.

6. A shade panel assembly as claimed in claim 1, wherein the support structure is removably connectable to the vehicle sun visor.

7. A shade panel assembly as claimed in claim 1, wherein the support structure is removably connectable to the vehicle sun visor via hook-and-loop fasteners.

8. A shade panel assembly as claimed in claim 4, wherein the laterally adjustable shade panel has a distal lateral edge relative to the support structure and wherein the vertically adjustable shade panel has a distal lateral edge relative to the support structure and wherein the vertically adjustable shade panel and the laterally adjustable shade panel are pivotally connected together proximate their distal lateral edges.

9. A shade panel assembly, comprising:
a support structure that removably connects to a vehicle sun visor;
a laterally adjustable shade panel that is laterally slidably connected to the support structure and is positionable in a position wherein the laterally adjustable shade panel is at least partially laterally outside of the vehicle sun visor; and
a vertically adjustable shade panel that is connected to the laterally adjustable shade panel and wherein the vertically adjustable shade panel is vertically movable relative to the laterally adjustable shade panel between a first position wherein the vertically adjustable shade panel extends substantially lower than the vehicle sun visor, and a second position wherein the vertically adjustable shade panel does not extend substantially lower than of the vehicle sun visor, wherein the vertically adjustable shade panel has a width that is less than a selected value.

10. A shade panel assembly as claimed in claim 9, wherein the selected value is selected based on the apparent width of the sun during selected periods of the day.

11. A shade panel assembly as claimed in claim 9, wherein the vertically adjustable shade panel is riveted via a grommet pivot to the lateral adjustment member.

12. A shade panel assembly, comprising:
a support structure that connects to a vehicle; and
a vertically adjustable shade panel that is connected to the support structure wherein the vertically adjustable shade panel is vertically adjustable relative to the support structure to position the vertically adjustable shade panel in a user-selected vertical position.

13. A shade panel assembly as claimed in claim 12, wherein the vertically adjustable shade panel is positionable in a first position wherein the vertically adjustable shade panel is not substantially lower than the laterally adjustable shade panel and a second position wherein the vertically adjustable shade panel is substantially lower than the laterally adjustable shade panel.

14. A shade panel assembly as claimed in claim 12, wherein the selected value is selected based on the apparent width of the sun during selected periods of the day.

15. A shade panel assembly as claimed in claim 12, wherein the vertically adjustable shade panel is riveted via a grommet pivot to the lateral adjustment member.

16. A shade panel assembly as claimed in claim 12, wherein the support structure is removably connectable to the vehicle via hook-and-loop fasteners.

17. A shade panel assembly as claimed in claim 12, wherein the support structure is removably connectable to the vehicle via suction cups.

18. A shade panel assembly as claimed in claim 12, wherein the vertically adjustable shade panel is removably connected to the support structure via magnetic attraction.
